(19) United States
(12) Patent Application Publication
(10) Pub. No.: US 2022/0274029 A1
(43) Pub. Date: Sep. 1, 2022

(54) Portable Multi-Purpose Doorway Swing Apparatus

(71) Applicant: Ala'a-eddeen Swidan, Saskatoon (CA)

(72) Inventor: Ala'a-eddeen Swidan, Saskatoon (CA)

(21) Appl. No.: 17/187,803

(22) Filed: Feb. 27, 2021

(51) Int. Cl. A63G 9/12; F16M 13/02; A63G 9/02

(52) U.S. Cl. CPC A63G 9/12; F16M 13/02; A63G 9/02

(57) ABSTRACT

A Portable Multi-Purpose Doorway Swing Apparatus consisting of a horizontal bar that sits on top of the horizontal doorway casing from one side of the wall and a longer horizontal bar that rests against the two vertical casings on the opposite side. The two horizontal bars are joined by two L-shaped bars. A securing mechanism is introduced by using a minimum of two screws that go through the L-shaped bar frame vertically to secure the apparatus in-place by pushing against the top jamb of the inner door frame. In-addition, a swing system consisting of two straps with ring on each end of the strap are joined by carabiners that create two points of attachment. Two ropes with loops on each end are then attached and an object like a swing seat or an infant car seat attach to the bottom to create a swing for use indoors and/or outdoors.

### TECHNICAL FIELD

The present invention relates to doorway apparatuses, and more specifically, portable doorway apparatuses for use in exercising or with a swing system. The swing system allows for an infant car seat, a child swing, or other playground type equipment to be used indoors and outdoors.

### BACKGROUND

When an infant is fussy, parents intuitively sway the baby from side to side to help calm the baby down, or to put the baby to sleep. Car seats generate similar soothing effects on infants when driven around in a vehicle or when parents gently sway the infant with the car seat back and forth or side to side. While this can help in soothing the baby, it is not always feasible to drive the infant around or to continuously swing the infant car seat by hand. Continuous swinging motion of the infant car seat by hand can create an unneeded stress on the back, shoulder and arm. This motion cannot be sustained for extended periods of time, and herein, this invention designs a solution for a portable indoor and outdoor infant car seat swing system.

A motion apparatus for use with infant car seat was disclosed by Gregorian, U.S. Pat. No. 8,777,764. This apparatus is based on a support structure that can hold an infant car seat allowing for motion activation. This set-up serves more for rocking motion with limited range of motion, is not easily portable, and takes up space which can be an issue in small living spaces.

With COVID-19 pandemic, there has been an increase in demand for in-house alternatives to outdoor activities that have been restricted, or limited. An outdoor playground is an example, and what is proposed herein is a design to bring different outdoor playground activities indoors, while still being able to use these attachments outdoors. This allows for the use of such equipment all year round, irrespective of weather conditions, access to playgrounds, or other limitations.

Pfefferle et al., U.S. Pat. No. 5,186,696 (and Pfefferle, U.S. Pat. No. 6,017,293) introduces a doorway bar support that is fixed to a doorway with rings connected to the bar assembly to allow for connecting playground type equipment including a swing.

The demand for portable doorway pull up bar systems increased, resulting in various designs being invented and created. Invention by Vanderbleek, U.S. Pat. No. 5,417,628 introduces a pull up bar design that uses a top horizontal bar that sits on-top of a horizontal doorway casing (or frame) from one side, while a second horizontal bar rests on two adjacent vertical casings on the other side. These horizontal bars are connected by two vertical L-shaped bars. While the design by Vanderbleek provides vertical stability, it will result in the apparatus falling if pushed horizontally, which can be the outcome of a movement generated by swinging motion. One approach to solve this problem is the invention by Velikin et al., U.S. Pat. Nos. 9,044,641, 9,616,264, where several embodiments are proposed. This approach is limited to connecting the attachments to an eyelet which does not allow a swing or other playground attachments to be used outdoors (for example, on a tree branch) without sourcing other parts. Additionally, the embodiment with vise clamp for securing the pull up bar in some cases relies on the use of a door jamb ridge that the door closes against, which by tightening the vise clamp, if the ridge is glued (as is the case in some in-house door frames) will result in vise clamps pulling the ridge off. This would result in the vise clamp failing to secure the pull up bar and the risk of the pull up bar falling.

The proposed portable doorway apparatus herein is designed to bring solutions to one or more of the issues outlined above.

### BRIEF DESCRIPTION OF THE DRAWINGS

FIG. 1 is a perspective view from the front of the portable doorway apparatus with the top portion of the swing system displayed.

FIG. 2 is a side view of the securing mechanism with the screw going through L-shaped bar and pushing against top jamb of the inner door frame.

FIG. 3 is a perspective view from the front of the lower portion of the first embodiment of swing system.

FIG. 4 is a perspective view from the front of the infant car seat connection to rope.

FIG. 5 is a perspective of first embodiment of lower portion of swing seat connection to rope.

FIG. 6 is a perspective of an alternative connection of swing seat to rope for first embodiment.

FIG. 7 is a perspective view for second embodiment of lower portion of swing system with a swing seat.

FIG. 8 is a top view of the doorway apparatus.

FIG. 9 is perspective view of the front of the swing system for outdoor use.

### BRIEF SUMMARY

The present invention introduces a Portable Multi-Purpose Doorway Swing Apparatus that incorporates a securing mechanism for a safe install of the apparatus on common doorways. A swing system is also introduced to attach an infant car seat for use indoors and/or outdoors; and allows attachments (commonly used in playgrounds) to be connected that include but not limited to: children's swing seat, gymnastic rings, a Trapeze Bar, and a climbing ladder. The apparatus by itself is a pull up bar that can be used as an exercise equipment.

The design of this invention comprises of a portable doorway apparatus that consists of two horizontal bars that are connected by two vertical L-shaped bars. The top horizontal bar rests on-top of a horizontal doorway casing (or frame) from one side, while the other horizontal bar rests on two vertical casings on the opposite side of the doorway. This apparatus is fastened to the doorway by the introduction of a securing mechanism that consists of at least one vertical screw that goes through each of the two L-shaped bars. Each screw comprises of a twistable knob at the bottom of the screw, at least one nut, and a stopper on top of the screw to protect the door jamb from the screw. Twisting of the knob in one direction moves the screw and stopper closer to the top jamb of the inner door frame, thus, pushing against the top jamb, and resulting in secured doorway apparatus, preventing it from falling. Twisting the knob the other direction moves the screw away from the top jamb of the inner door frame, thus, allowing the doorway apparatus to be securely and easily dismounted without the need for drilling holes in the doorway.

A swing system comprising of two straps with metal rings on both ends along with two carabiners are used to wrap around the doorway apparatus to establish two secure connection points for a swing or other playground attachments. To use as a swing, two adjustable ropes are used with loops on both ends. One loop (top loop) of the rope connects to the height adjuster while the other loop (lower loop) of the rope creates a point of attachment. This rope is first hung by using the carabiner of the swing system (connecting the straps). In one embodiment, the lower loop is then used in combination with a carabiner to attach an infant car seat (or a swing seat). In another embodiment, the lower loops are directly attached to a swing seat. Note that the infant car seat handle must be in a carry (upright) position, meaning it must point perpendicular to the floor to properly connect and swing the infant car seat.

In the first embodiment, the lower loop of the rope is connected to the infant car seat handle or swing seat by using a carabiner to connect the lower loop to the object, or by having the rope wrap around the object and attaching the carabiner to the rope itself to secure.

In addition to use with the portable doorway apparatus, the straps can be used to wrap around any stable and elevated point of attachment, indoors or outdoors, allowing the swing system to be used in various locations and settings. For example, the straps can be used to wrap around objects that include but are not limited to a bar or a tree branch. In-addition, the swing system allows for connecting other playground attachments on the doorway apparatus, indoors or outdoors. The carabiner connecting two straps is to be used to make the connection to the other playground attachments.

### DETAILED DESCRIPTION

The inventor provides a portable multi-purpose doorway swing apparatus for use in creating a doorway apparatus that is secured by incorporating a securing mechanism. A swing system is additionally introduced to allow for attaching a swing using an infant car seat, a child swing, or other common playground attachments for use with the doorway apparatus or for other indoor and/or outdoor applications. The present invention is described in enabling detail in the following examples, which may represent more than one embodiment of the present invention.

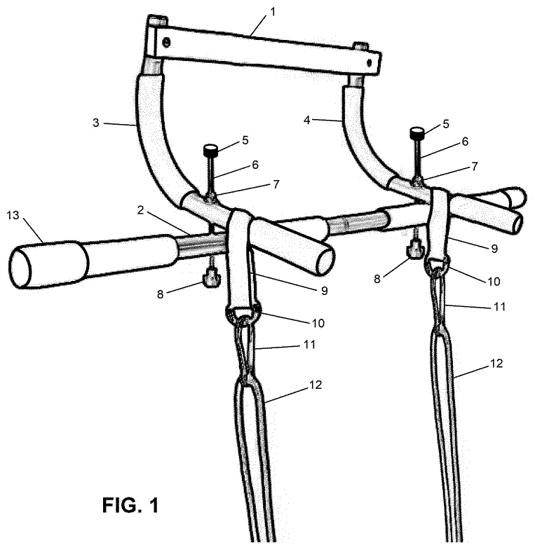

FIG. 1 is a perspective view from the front of the portable doorway apparatus with the top portion of the swing system displayed. The apparatus consists of a top horizontal bar 1 that connects to the top portion of the L-shaped bars 3 and 4. This top horizontal bar will be sitting on-top of a doorway casing, as will be described below. The L-shaped bars 3 and 4 connect to the lower horizontal bar 2. The L-shaped bars are connected to the top and lower horizontal bars by any means of attachment that include but not limited to bolts, screws, nets, welds, or other. The lower horizontal bar will extend in length to cover an area that is appropriate to cover the distance between vertical casings of a standard doorway. Note that the point of contact from 2 will be on the opposite side of the doorway than 1. 1 will be sitting on-top of the top casing from one side, while 2 will rest on the vertical casings from the other side. Each ending of the lower horizontal bar 2 has paddings 13 to protect the doorway from the metal bar.

In FIG. 1, the apparatus contains a securing mechanism that consists of two long screws 6 that vertically go through the two L-shaped bars 3 and 4. The screws themselves comprise of a twistable knob 8 at the bottom of the screw, and a stopper 5 at the top of the screw. The knob 8 is used to create a handle for turning the screw in one direction that moves the screw closer to the top jamb of the inner door frame, thus, securing the doorway apparatus in-place, preventing it from falling. Turning the knob the other direction moves the screw away from the top jamb of the inner door frame. A stopper 5 is used to prevent the screw from damaging the doorway by creating a surface to distribute the pressure from the screw end. The screw 6 is tightened against the L-shaped bars 3 and 4 using at least one nut 7, that can be unattached or attached to the L-shaped bar by welding or other means of attachment, or it can be used in combination with other washers and/or locking washers to help secure the nut in-place as the knob is twisted.

FIG. 1 additionally depicts the straps 9 that wrap around the intersection of the L-shaped bar 3 (and 4), and the lower horizontal bar 2 creating a swing system. Each strap contains a ring 10 at each end of the strap that can be joined together using a carabiner 11. The carabiner is then used as a point of attachment for various playground attachments. In the example illustrated in FIG. 1, a rope 12 is attached to each carabiner.

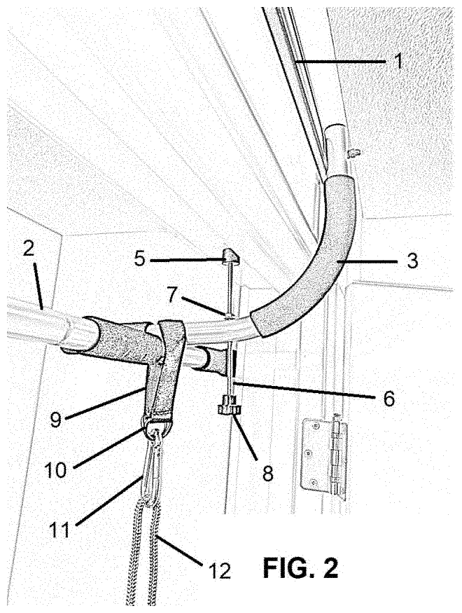

FIG. 2 is a side view of the securing mechanism with the screw 6 going through L-shaped bar 3. The top of the screw consists of a stopper 5 that is pushing against the top jamb of the inner door frame. Stopper 5 is used to protect the top jamb from the screw. This stopper can be attached to the screw by different means of attachment that include but not limited to a piece with an internal female thread to attach to the screw, or simply a hole through the stopper that slides over and covers the screw end. The stopper can be made from rubber, plastic, or other materials that create a surface to distribute the force from the screw over a larger area.

FIG. 2 also consists of a twistable knob 8 that is used to tighten the screw against the top jamb of the inner door frame by twisting in one direction. Twisting in the opposite direction moves the screw away from the top jamb of the inner door frame. The knob can be made of different materials and can be attached to the screw by means of molding, threading, welding, or other means of attachment. The knob can consist of any shape that allows a hand or fingers to grab and rotate the screw. A nut 7 is used to secure the screw in place as it is twisted and keeps the screw secured once tightened. The nut 7 can be free, directly attached to the bar by any mean of attachment like welding or it can be molded within the L-shaped bar. A free nut can be used by itself, or in-combination with a washer and/or locking washer.

FIG. 2 illustrates the side view of the swing system, with the metal rings 10 at the end of the straps 9 being joined by a carabiner 11 with a rope 12 connected to the carabiner. In-addition, FIG. 2 displays the mounting of the top horizontal bar 1 on top of the doorway casing (frame) from one side and the resting of the lower horizontal bar 2 on a vertical casing on the opposite side of the wall.

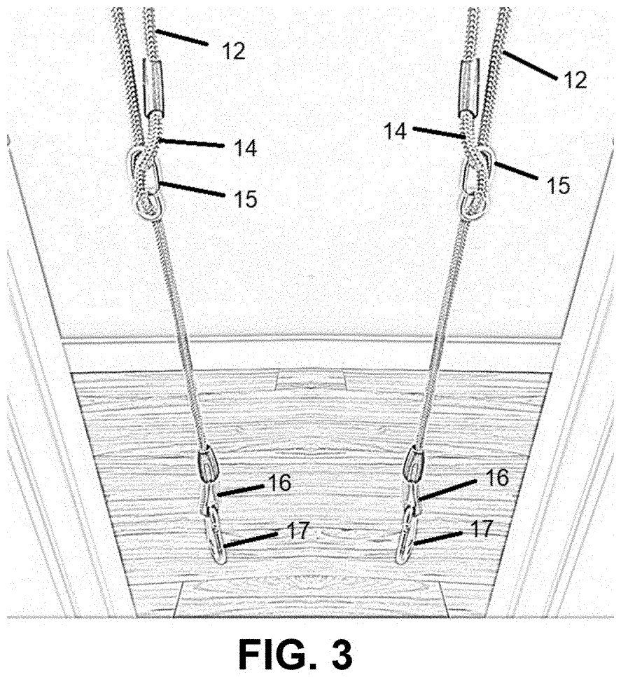

FIG. 3 is a perspective view from the front of the lower portion of the first embodiment of swing system. Each rope 12 would be connected to the doorway apparatus through a carabiner as previously illustrated in FIG. 1 and FIG. 2. Rope 12 consists of a height adjuster 15 that allows the swing to be operated at different heights. Rope 12 consists of loops at each end. The top loop 14 of rope 12 connects to the height adjuster 15, while the bottom loop 16 of the rope 12 connects to carabiner 17.

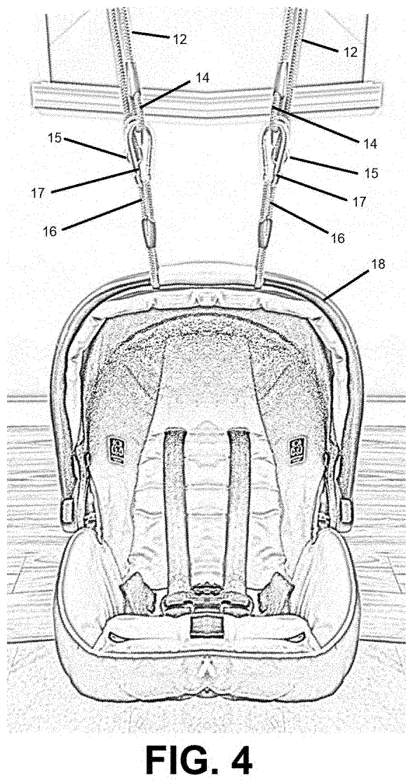

FIG. 4 is a perspective view from the front of the infant car seat connection to rope. With car seat handle 18 in an upright position (perpendicular to the floor), the bottom loop 16 and carabiner 17 from each rope are wrapping around the car seat handle 18 and the carabiner 17 is then connected the top loop 14 of the respective rope. Alternatively, the carabiner 17 can be hooked to the rope itself after wrapping around the car seat handle 18 and not necessarily the top loop 14.

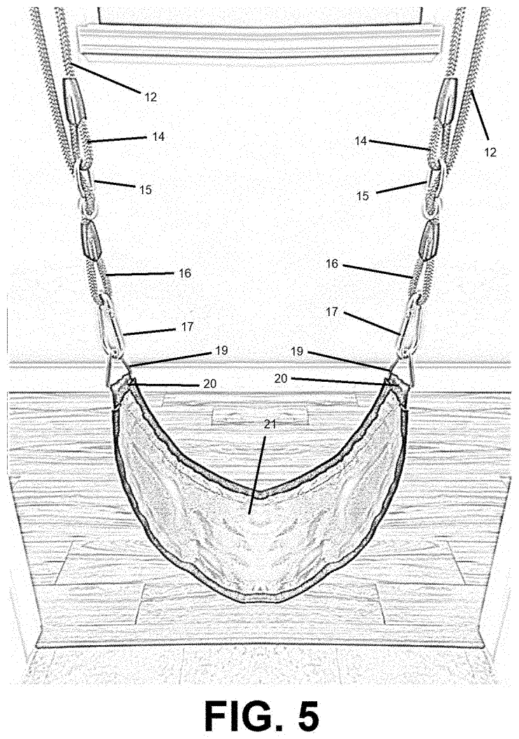

FIG. 5 is a perspective of first embodiment of lower portion of a swing seat 21 connection to rope 12. The swing seat 21 has two swing loops 20 at each end that connect a swing metal ring 19 first prior to connecting to a carabiner 17. Alternatively, swing loops 20 can connect directly to the carabiner 17 without the use of a metal ring in-between.

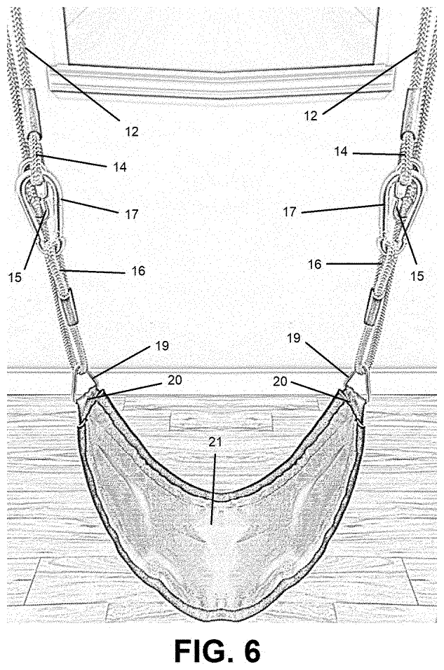

FIG. 6 is a perspective of an alternative connection of swing seat to rope for first embodiment. In this alternative connection method, the bottom loop 16 of rope 12 runs through a metal ring 19 or swing loop 20 prior to being connected to the top loop 14 via a carabiner 17. The carabiner 17 can alternatively be connected to the rope 12 directly after wrapping around 19 or 20 and not necessarily the top loop 14.

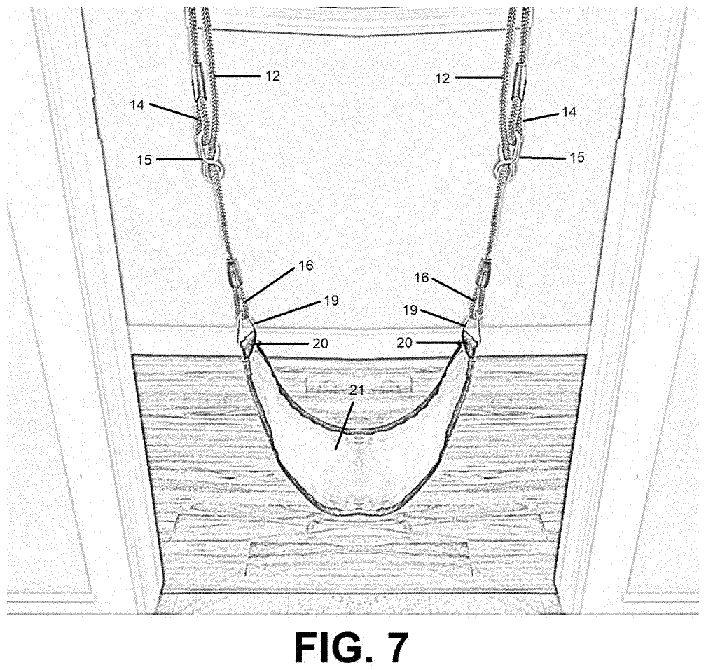

FIG. 7 is a perspective view for second embodiment of lower portion of swing system with a swing seat 21. In this embodiment, the loop end 16 of rope 12 is directly connected to the metal ring 19. Alternatively, they can be joined together by other means of attachment that include but not limited to directly attaching 16 to swing loop 20 or stitching (or other forms of attachment) the rope to the swing seat.

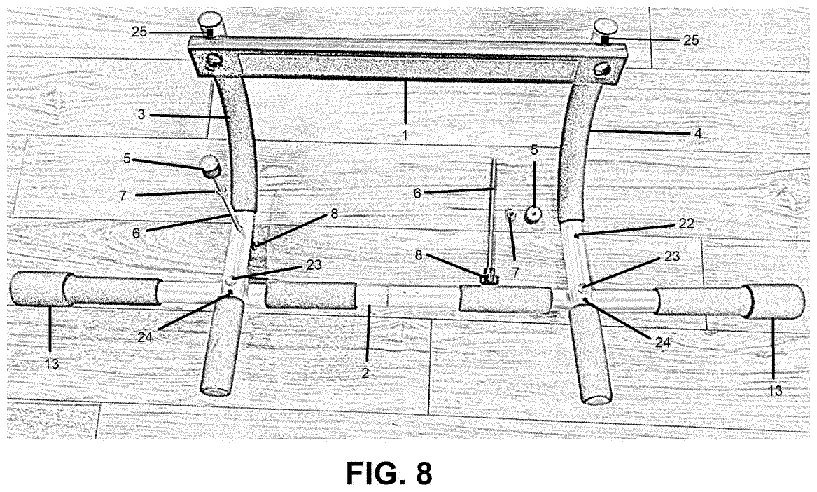

FIG. 8 is a top view of the doorway apparatus. Swing system is not connected in FIG. 8 to show the point of attachment of horizontal bar 2 and the L-shaped bars 3 and 4 using bolt 23. More than one hole can be included on the L-shaped bar as illustrated by 24 and 25 to accommodate wider door frames and larger door casings, thus, making this doorway apparatus fitting for doors with various door frame widths and casing heights.

FIG. 8 shows the left L-shaped bar 3 with screw 6 going through the bar. Right L-shaped bar 4 shows the hole 22 where the screw 6 would go through. This is an approximate location, and more than one hole may be added to allow the user to select a hole that would best align with the top jamb of the inner doorway frame.

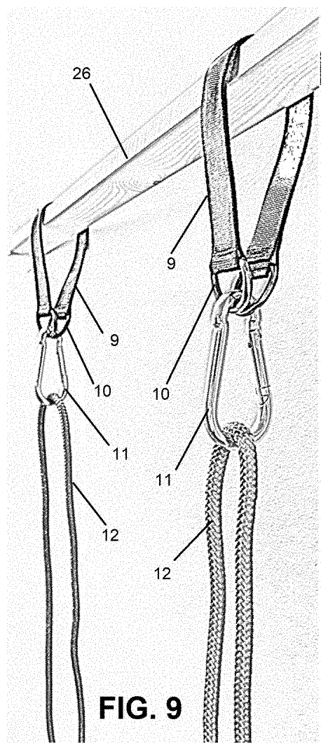

FIG. 9 is a perspective view of the front of the swing system for outdoor use. The straps 9 wrap around a wood lumber 26 in this example, with the metal rings 10 of each end joined together by a carabiner 11. The wood lumber can be a bar, a tree branch, or any another sturdy elevated point of attachment. This allows for the use of the swing system for other indoor and outdoor applications in-addition to the doorway apparatus. It can be combined with an infant car seat swing, child swing, or other attachments commonly used in playgrounds.

It will be apparent to one with skill in the art that a portable doorway apparatus with securing mechanism may be provided using some or all of the mentioned features and components without departing from the spirit and scope of the present invention. It will also be apparent to one with skill in the art that a swing system may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

I claim:

1. A portable doorway apparatus for use on doorway frame comprising:
A horizontal bar that sits on-top of a door casing from one side and connects to two L-shaped bars;
A longer horizontal bar that rests against the vertical casings of the door from the other side and connect to the lower portion of the two L-shaped bars;
At least one screw per L-shaped bar is used as a securing mechanism to safely secure the doorway apparatus in-place and prevent it from falling.

2. The portable doorway apparatus of claim 1, wherein at least one hole is created on each L-shaped bar to allow for a vertical screw to go through the bar.

3. The portable doorway apparatus of claim 1, wherein at least one vertical screw goes through each L-shaped bar and is used to secure the apparatus against the top jamb of the inner door frame.

4. The portable doorway apparatus of claim 2, wherein the vertical screw consists of a twistable knob at the bottom of the screw, whereby twisting of the knob one direction moves the screw closer to the top jamb of the inner door frame and twisting in the other direction moves the screw away from the top jamb of the inner door frame.

5. The portable doorway apparatus of claim 2, wherein the vertical screw consists of a stopper at the top end of the screw to protect the top jamb of the inner door frame from the screw by distributing the force applied by the screw when pushed against the frame surface.

6. The portable doorway apparatus of claim 2, wherein the vertical screw is secured in-place by using at least one nut to keep the screw secured as it is turned and to remain secured once tightened.

7. The portable doorway apparatus of claim 1, wherein the L-shaped bar consists of at least one hole at the higher end of the bar for attachment of the top horizontal bar, and at least one hole at the lower end of the bar for attachment to the longer horizontal bar. Additional holes would allow for accommodation of various doorway frame widths and casing heights.

8. The portable doorway apparatus of claim 1, wherein the longer horizontal bar consists of padding at each end to protect the vertical casings of the door.

9. A swing system comprising of:
Two straps that would wrap around an elevated object like a bar;
Each strap is secured by using rings on each end that are joined together by a carabiner, thus, creating a point of attachment.

10. The swing system of claim 9, wherein the top carabiner of each strap connects a hanging rope or other playground equipment.

11. The swing system of claim 10, wherein the hanging rope contains loops at each end, with one loop (top loop) connected to a height adjuster, and the other loop (bottom loop) creates a point of attachment.

12. The swing system of claim 11, wherein the bottom loop of the rope creates an attachment point. The bottom loop is used in combination with a carabiner to wrap around an object like a car seat handle, a swing seat, or other objects to be attached to the rope. The carabiner is then connected back with the rope, thus, resulting in the object being attached to the rope.

13. A swing system comprising of:
Two straps that would wrap around an elevated object like a bar;
Each strap is secured by using rings on each end that are joined together by a carabiner, thus, creating a point of attachment.

14. The swing system of claim 13, wherein the top carabiner of each strap connects a hanging rope or other playground equipment.

15. The swing system of claim 14, wherein the hanging rope contains loops at each end, with one loop (top loop) connected to a height adjuster, and the other loop (bottom loop) creates a point of attachment.

16. The swing system of claim 15, wherein the bottom loop of the rope creates an attachment point that is directly attached to a swing seat, thus creating a child swing system.
